(19) United States
(12) Patent Application Publication
(10) Pub. No.: US 2023/0255376 A1
(43) Pub. Date: Aug. 17, 2023

(54) BEVERAGE ENTERTAINMENT GLASS, REMOTE TOAST COUNTER SYSTEM

(71) Applicant: Netappli Co., Ltd., Kahoku-gun (JP)

(72) Inventor: Makoto NISHIDA, Kahoku-gun (JP)

(21) Appl. No.: 18/303,988

(22) Filed: Apr. 20, 2023

Related U.S. Application Data
(63) Continuation of application No. PCT/JP2021/024540, filed on Jun. 29, 2021.

(30) Foreign Application Priority Data
Oct. 22, 2020 (JP) 2020-187600

(51) Int. Cl. A47G 19/22; G06Q 50/10

(52) U.S. Cl. CPC A47G 19/2227; G06Q 50/10

(57) ABSTRACT

The beverage entertainment glass includes a glass body that is a tubular body with a bottom having an upper opening, a side frame that has a fixing mechanism configured to fix an image display device to the glass body, and a ring frame that is in a ring shape and into which the glass body and the side frame are inserted together. By inserting the glass body and the side frame into the ring frame in a state where a first connection surface and a second connection surface are connected, one contact surface of a third protrusion part contacts a first curved surface, and by rotating the ring frame in a state where the one contact surface is in contact with the first curved surface, the second protrusion part connects to the first protrusion part such that the glass body is fixed to the side frame.

### CROSS REFERENCE TO RELATED APPLICATIONS

This application is a continuation of a PCT application No. PCT/JP2021/24540 filed on Jun. 29, 2021, which is based on and claims priority to Japanese Patent Applications No. 2020-187600 filed on Oct. 22, 2020, the disclosures of which are incorporated herein by reference.

### TECHNICAL FIELD

The present invention relates to a beverage entertainment glass and a remote toast counter system in which a storage part for fixing an image display device can be easily exchanged/replaced.

### BACKGROUND

Glasses with various functions other than a function of holding beverages have been developed.

For example, Patent Documents 1 and 2 disclose techniques for placing a display device on a glass surface, manually switching an image displayed on the display device, or automatically switching the displayed image according to an output of a motion sensor that detects the state of the glass.

Patent Documents 3 to 5 disclose beverage entertainment glasses invented by the inventors of the present application. The beverage entertainment glass includes a glass body, a storage part that extends inward from the bottom of the glass body for storing a portable communication device, and a conductive wave part that extends inward from a side surface of the glass body for allowing radio waves to pass through it. The beverage entertainment glass wirelessly communicates by guiding the radio waves from the portable communication device to the outside through the conductive wave part, even when the glass body is filled with a beverage.

Patent Document 6 discloses a beverage entertainment glass invented by the present inventor of the present application. The beverage entertainment glass is provided with an image display device fixed to a glass side and a reflecting mirror arranged inside the glass body, and an image of the image display device can be projected inside the glass in a simulated manner.

### PRIOR ART

### Patent Related Document(s)

[Patent Doc. 1] JP Laid-Open Patent Application Publication 2005-99159

[Patent Doc. 2] US Patent Application Publication 2008/0100469

[Patent Doc. 3] JP Patent 6337256

[Patent Doc. 4] JP Patent 6406742

[Patent Doc. 5] JP Patent 6432960

[Patent Doc. 6] JP Patent 6488049

### OBJECTIVE(S) OF THE INVENTION

However, the products disclosed in Patent Documents 1 to 6 above have a drawback(s) that a storage part for storing an image display device cannot be changed in size according to a size of a mobile phone or a smartphone, or the user's preference.

Considering the above drawback(s), the present invention was created to provide a beverage entertainment glass in which a storage part for storing an image display device is configured to change in size according to a mobile phone or smartphone size, or the user's preference.

Also, another objective is to provide a remote toast counter system using the beverage entertainment glass.

### SUMMARY

A beverage entertainment glass disclosed in the present application includes a glass body that is a tubular body with a bottom having an upper opening; a side frame that has a fixing mechanism configured to fix an image display device to the glass body; and a ring frame that is in a ring shape and into which the glass body and the side frame are inserted together, wherein the glass body has a first curved surface that is curved on a side surface near a bottom thereof, the glass body has a first connection surface at a position facing the first curved surface, the side frame has a second curved surface that is curved on a side surface near a bottom thereof, the side frame has a second connection surface at a position facing the second curved surface, a first protrusion part is provided on the second curved surface, a curvature radius of the first curved surface and a curvature radius of the second curved surface are equal, a second protrusion part that is connected to the first protrusion part is provided on an inner peripheral surface of the ring frame, a third protrusion part is provided on an inner peripheral surface of the ring frame, the third protrusion part includes at least one contact surface that contacts any portion of the first curved surface, by inserting the glass body and the side frame into the ring frame in a state where the first connection surface and the second connection surface are connected, the one contact surface of the third protrusion part contacts the first curved surface, and by rotating the ring frame in a state where the one contact surface of the third protrusion part is in contact with the first curved surface, the second protrusion part connects to the first protrusion part such that the glass body is fixed to the side frame.

The beverage entertainment glass may further include a rotation stopper mechanism that holds or fixes the glass body and the side frame in a state where the glass body and the side frame are screwed into the ring frame.

The beverage entertainment glass may further include a clamping mechanism that is in a U-shape and clamps an end of the upper opening and an upper part of the side frame.

The beverage entertainment glass may further include the ring frame is provided with a bottom plate that protects a bottom surface of the glass body.

The beverage entertainment glass may be characterized in that the beverage entertainment glass includes a plurality of the first protrusion parts and/or a plurality of the second protrusion parts.

The beverage entertainment glass may be characterized in that the any portion of the first curved surface, which contacts the one contact surface of the third protrusion, is raised in a protrusion shape.

The beverage entertainment glass may further include a lid that closes the upper opening.

The beverage entertainment glass may be characterized in that the image display device is a part of a portable communication device.

The beverage entertainment glass may be characterized in that, instead of the first protrusion part, a connection adhering surface is provided on the second curved surface, the connection adhering surface connecting to or adhering to the second protrusion part.

A remote toast counter system disclosed in the present application includes the beverage entertainment glass discussed above; the portable communication device that has an acceleration sensor or camera sensor; an external server computer that communicates with the portable communication device via a network; and a user operation detection part that receives output data of the acceleration sensor or camera sensor from the portable communication device, wherein the user operation detection unit, detects that the user moved, tilted, or collided the beverage entertainment glass with another object based on the output data of the acceleration sensor or camera sensor of the portable communication device, and transmits an output signal related to the output date to the external server computer, and the external server computer receives the output signal, and calculates a toast operation cumulative number by counting the number of receptions of the output signals from the user operation detection part such that the user can view the toast operation cumulative number.

A beverage entertainment glass disclosed in the present application includes a glass body that is a tubular body with a bottom having an upper opening; a side frame that has a fixing mechanism configured to fix an image display device to the glass body; and a ring frame that is in a ring shape and into which the glass body and the side frame are inserted together, wherein the glass body has a first curved surface that is curved on a side surface near a bottom thereof, the glass body has a first connection surface at a position facing the first curved surface, the side frame has a second curved surface that is curved on a side surface near a bottom thereof, the side frame has a second connection surface at a position facing the second curved surface, a connection adhering surface is provided on the second curved surface, the connection adhering surface connecting to or adhering to the second protrusion part, a curvature radius of the first curved surface and a curvature radius of the second curved surface are equal, a second protrusion part that is connected to the connection adhering surface is provided on an inner peripheral surface of the ring frame, a third protrusion part is provided on an inner peripheral surface of the ring frame, the third protrusion part includes at least one contact surface that contacts any portion of the first curved surface, by inserting the glass body and the side frame into the ring frame in a state where the first connection surface and the second connection surface are connected, the one contact surface of the third protrusion part contacts the first curved surface, by rotating the ring frame in a state where the one contact surface of the third protrusion part is in contact with the first curved surface, the second protrusion part connects to the connection adhering surface such that the glass body is fixed to the side frame, and the any portion of the first curved surface, which contacts the one contact surface of the third protrusion, is raised in a protrusion shape.

### Advantages of the Invention

The side frame on which the fixing mechanism (or storage part) for fixing the image display device is provided is attached or detached simply by screwing (or turning) it into the ring frame at the bottom of the ring together with the glass body.

Since the side frame is attached or detached simply by rotating the ring frame, the user attaches or detaches side frames having various shapes according to the user's preferences.

Coasters with various designs are attached to the glass simply by exchanging the ring frame.

Since the ring frame is located at or near the bottom of the glass, even when the height of the glass body is high (that is, the center of gravity is high and the glass body easily falls over), the glass body can be prevented from falling over simply by exchanging/replacing the ring frame with a larger one. Therefore, the present invention is applied to glass bodies having various heights.

Since the glass body itself functions as a part of the screw shaft, there are fewer moving parts than another fixing mechanism of the image display device that uses a multi-axis arm, etc., so that the invented glass is structurally strong.

Because a spoon, sugar cube, etc. can be placed on the ring frame instead of a coaster, the invented glass provides a hygienically desirable environment.

There is an advantage that the side frame (that is, fixing mechanism) can be exchanged/replaced according to the size of the image display device or the portable communication device.

With the rotation stopper mechanism for holding or fixing the ring frame under a state where the glass body and the side frame are screwed into the ring frame, the glass body and the side frame, which are screwed into the ring frame, are prevented from loosening or falling off even when the glass body collides with another glass by toasting.

With the U-shaped clamp mechanism that clamps the end of the upper opening of the glass body and the upper part of the side frame, the glass body is firmly fixed to the side frame with both the upper and lower parts of the glass body.

The beverage entertainment glass does not need to provide any protrusions for connection on the glass body side. Therefore, it is easy to cast (or manufacture) the glass body in a mold.

By applying thread processing to a portion on the side of the ring frame where the glass body (or side frame) contacts (or closely contacts) when the glass body and the side frame are screwed into the ring frame, these three parts that are the glass body, the side frame and the ring frame are firmly integrated and fixed.

### BRIEF DESCRIPTION OF THE DRAWINGS

FIG. 1 is a cross-sectional view showing a beverage entertainment glass according to a first embodiment.

FIG. 2 is an upper cross-sectional view showing the beverage entertainment glass of the first embodiment.

FIGS. 3A and 3B are enlarged cross-sectional views showing the exemplary shape of a connection part between a first protrusion part and a second protrusion part.

FIG. 4 is a cross-sectional view showing an example of a contact surface between a third protrusion part and the first curved surface.

FIG. 5 is a cross-sectional view showing a bottle-shaped beverage entertainment glass.

FIG. 6 is a cross-sectional view showing an example in which a ring frame is provided with a plate-like bottom plate.

FIG. 7 is a top sectional view showing an example provided with a rotation stopper mechanism.

FIG. 8 is a cross-sectional view showing an example provided with a clamping mechanism.

FIGS. 9A, 9B, and 9C are perspective views showing side frames in various shapes.

FIGS. 10A, 10B, and 10C are perspective views showing ring frames in various shapes.

FIG. 11 is a diagram showing the configuration of a remote toast counter system.

FIG. 12 is a cross-sectional view showing an example in which a connection adhering surface is provided instead of the first protrusion.

### DETAILED DESCRIPTIONS OF THE PREFERRED EMBODIMENT(S)

### First Embodiment of Beverage Entertainment Glass

The first embodiment of the beverage entertainment glass of the present invention is shown below referring to the drawings.

As shown in FIG. 1, beverage entertainment glass 1 is composed of glass body 10, side frame 20, fixing mechanism 21, and ring frame 30 as a whole.

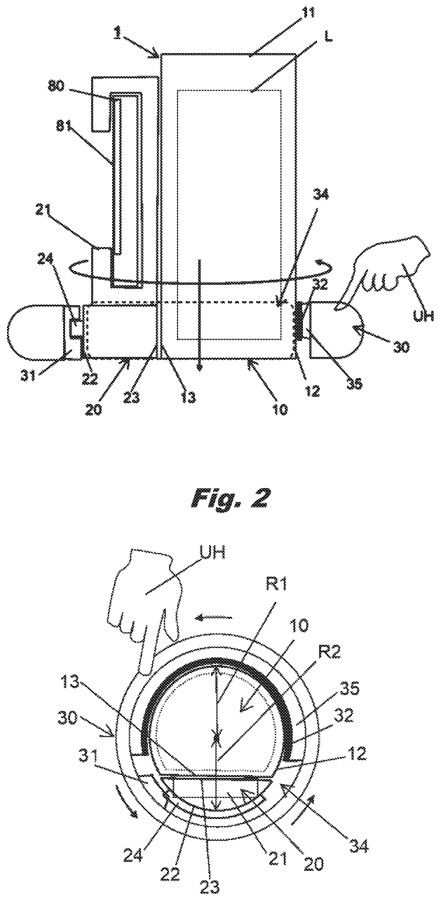

Glass body 10 is a tubular body with a bottom having upper opening 11. The tubular body is configured to be filled with beverage L such as a soft drink or an alcoholic beverage. As the material of glass body 10, transparent glass, resin, pottery, and porcelain etc., are available in the same manner as ordinary glasses. The shape of glass body 10 may be in a cylindrical shape that is normal cup-shaped as shown in FIG. 1, or a bottle shape having lid 15 for closing upper opening 11 as shown in FIG. 5. As shown in FIGS. 1 and 2, glass body 10 has first curved surface 12 either at the bottom or at a side surface near the bottom, and first curved surface 12 and first connection surface 13 are arranged oppositely on the opposite sides of glass body 10.

Side frame 20 is a member that is configured to fix (or support) image display device 80 to the side surface of glass body 10. Side frame 20 has fixing mechanism 21 that is configured to fix image display device 80 to the side surface of the glass body. In the example of FIG. 1, image display device 80 is fixed to side frame 20 using a U-shaped storage part as fixing mechanism 21. A screw mechanism, a magnet mechanism, or a storage part (pocket) having another shape may be used as fixing mechanism 21. As shown in FIGS. 1 and 2, side frame 20 is provided with second curved surface 22 either at the bottom or at a side surface near the bottom, and second curved surface 22 and second connection surface 23 are arranged oppositely on the opposite sides of side frame 20. First protrusion part 24 is provided on second curved surface 22.

Ring frame 30 is a ring member (or ring-shaped member) that is configured such that glass body 10 and side frame 20 are inserted and integrated together. Second protrusion part 31 that connects to first protrusion 24 is provided on inner peripheral surface of ring frame 30. Third protrusion part 35 is provided on the inner peripheral surface of ring frame 30, and at least one of contact surface 32 that contacts (or adheres to) any portion of first curved surface 12 is provided at the tip of third protrusion part 35. It is noted that contact surface 32 does not necessarily have to be placed at the tip of third protrusion part 35 as in the example of FIG. 1. Contact surface 32 may be, for example, at the upper portion, the lower portion, or the corner of third protrusion part 35. Contact surface 32 may be placed dispersedly in plural locations.

As shown in FIG. 2, beverage entertainment glass 1 is adjusted such that curvature radius R1 of first curved surface 12 is equal (or substantially equal) to curvature radius R2 of second curved surface 22. Therefore, as shown in FIGS. 1 and 2, glass body 10 (first curved surface 12 thereof) and side frame 20 (second curved surface 22 thereof) are integrated and form a single cylindrical shaft (screw shaft) by connecting first connection surface 13 to second connection surface 23. As a result, it is possible that glass body 10 and side frame 20 are screwed into ring frame 30 (fixed by being screwed) under a state where first connection surface 13 and second connection surface 23 are connected. This screwing process will be described later in details. First, by inserting glass body 10 and side frame 20 into ring frame 30 in a state where first connection surface 13 and second connection surface 23 are connected, third protrusion part 35 contacts (or adheres to) any portion of first curved surfaces 12. Next, second protrusion part 31 is connected to first protrusion part 24 by rotating ring frame 30 under a state where third protrusion part 35 is in contact with (or adheres to) any portion of first curved surface 12. As a result, glass body 10 is fixed to side frame 20. By integrating glass body 10 and side frame 20, glass body 10 and side frame 20 function like one screw shaft so that side frame 20 is firmly fixed to glass body 10.

Because glass body 10 and side frame 20 are screwed into the ring frame with the protrusion parts individually, even if glass body 10 is tilted during toasting or turned upside down, side frame 20 does not fall off. Even if a force is applied in a direction in which first connection surface 13 and second connection surface 23 are separated, the diameter of the cylindrical shaft (screw shaft) formed with glass body 10 and side frame 20 will be increased by the amount of the force. As a result, the stress with which ring frame 30 tightens glass body 10 and side frame 20 will be further strengthened. Since glass body 10 and side frame 20 are screwed into the ring frame, unlike a case where glass body 10 and side frame 20 are united together with a simple structure such as a belt or a string, side frame 20 does not come off from glass body 10 even glass body 10 is tilted in various directions such as up-down or left-right.

Beverage entertainment glass 1 of the present invention does not need to be provided with a protrusion part for connection on a side of glass body 10. Casting glass body 10 with a mold is very simple. If a protrusion part is provided on a surface of the cylindrical body when casting a cylindrical glass with a mold, the protrusion part will cause an undercut portion. The cost of casting will increase significantly due to the structure. Or, in the worst case, the structure cannot be manufactured by casting.

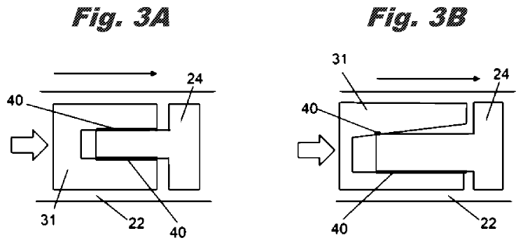

FIGS. 3A and 3B show examples of shapes of the first and second protrusion parts. It is noted that FIGS. 3A and 3B are enlarged cross sectional views showing exemplary shapes of the connection part between the first protrusion part and the second protrusion part when seen in the direction of second curved surface 22 from a side of ring frame 30.

As long as first protrusion part 24 and second protrusion part 31 are connected, there is no particular limitation on the shapes of the first protrusion part and the second protrusion part. As shown in FIG. 3A, a combination of a U-shaped second protrusion part 31 and protruding first protrusion part 24 that is configured to be inserted into second protrusion 31 may be available. As shown in FIG. 3B, second protrusion part 31 may has a shape sandwiching first protrusion part 24. Also, the shapes of the first and second protrusion parts may be in well-known thread shape such that first protrusion part and second protrusion part are screwed together.

At connection part 40 between first protrusion part 24 and second protrusion part 31, the larger the area of the connection part is, the greater the friction therebetween becomes. As a result, the bonding strength between first protrusion part 24 and second protrusion part 31 increases. That is, the fixing strength between glass body 10 and the side frame increases. In consideration of the point, in order to enlarge the area of connection part 40 between first protrusion part 24 and second protrusion part 31, not only one pair of the first and second protrusion parts but a plurality of the first and second protrusion parts also may be provided.

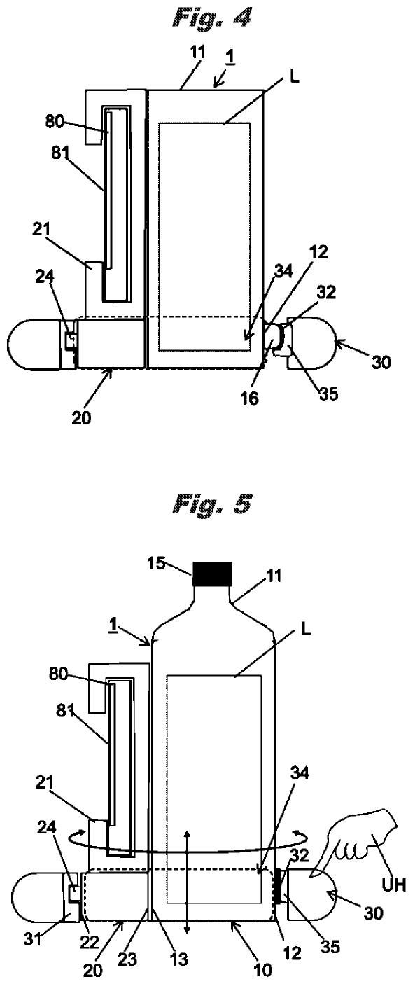

As shown in FIG. 4, a portion of first curved surface 12 that contacts (or adheres to) third protrusion part 35 may be raised in a protruding shape. (In the beverage entertainment glass of the present invention, the shape of first curved surface 12 does not matter as long as it can come into contact with third protrusion part 35 of first curved surface 12). As shown in FIG. 4, first curved surface 12 is provided with protrusion part 16 that is raised in a protruding shape, and third protrusion part 35 has a shape connecting to protrusion part 16. Thereby the fixing strength of contact surface 32 increases. (In other words, the fixing strength between glass body 10 and ring frame 30 increases). By forming the shapes of first curved surface 12 (or protuberance 16) and third protrusion part 35 into known thread shapes, the fixing strength of the contact (or adhering) portion of first curved surface 12 that contacts third protrusion 35 may be further increased.

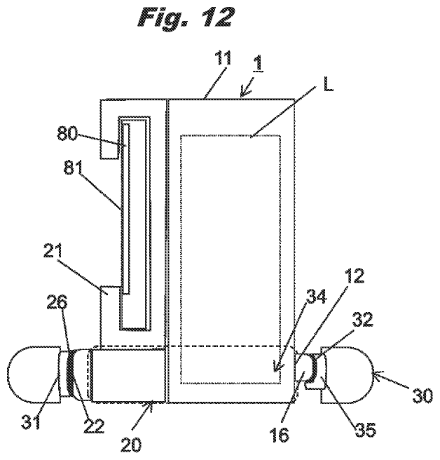

Further, as shown in FIG. 12, second curved surface 22 may be provided with a connection adhering surface 26 that connects to (or adheres to) second protrusion part 31 instead of first protrusion part 24. As described above, the beverage entertainment glass of the present invention may have any shape as long as first protrusion part 24 and second protrusion part 31 are connected. First protrusion part 24 may have a flat shape like connection adhering surface 26 shown in FIG. 12. Namely, that is an embodiment in which a flat surface contact or a flat surface adhesion is created. In addition, connection adhering surface 26 may be covered with a material having high friction (rubber or the like) in order to increase the strength of connection or adhesion to second protrusion part 31. Connection adhering surface 26 may have any shape as long as it connects to or adheres to second protrusion part 31, and may be a flat surface, a curved surface, or a recessed surface having a recess.

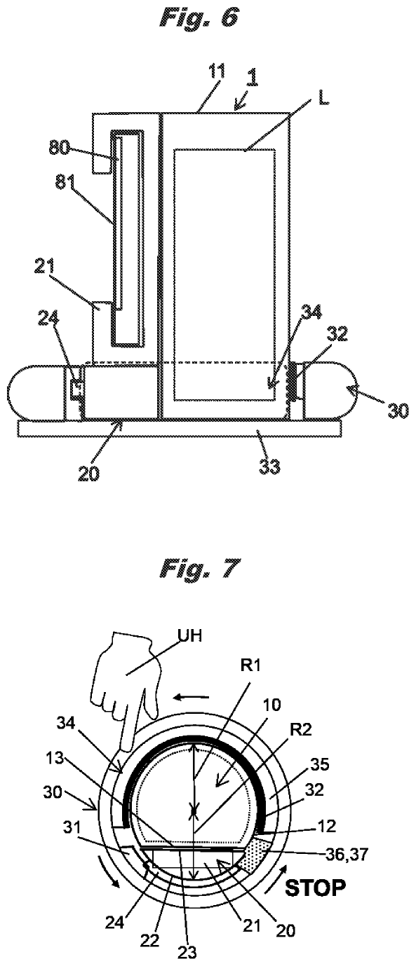

As shown in FIG. 6, a configuration in which a bottom plate 33 is provided on either one surface of ring frame 30 may be employed. Bottom plate 33 not only functions as a bottom stopper when glass body 10 or side frame 20 is screwed in, but also functions as a bottom plate for protecting the bottom surface of glass body 10.

As shown in FIG. 7, rotation stopper mechanism 36 may be provided for holding or fixing in a state where glass body 10 and side frame 20 are screwed in ring frame 30. When glass body 10 collides with another glass (during a toasting motion, etc.), rotation stopper mechanism 36 completely prevents glass body 10 and side frame 20, which are screwed into ring frame 30, from loosening (or coming off).

One specific method example for rotation stopper mechanism 36 is to insert rubber sheet 37 that prevents rotation due to its friction into a gap between side frame 20 and ring frame 30 as rotation stopper mechanism 36 as shown in FIG. 7. (In other words, it becomes difficult for side frame 20 and glass body 10 inside ring frame 30 to rotate due to the friction of rubber sheet 37). Other rotation stopper mechanisms 36 include a method of using a magnet mechanism, a method of using locking claws, and a method of using double-sided tape. Additionally, another method for the rotation stopper mechanism is to completely stop the rotation of glass body 10 and side frames 20 inside ring frame 30 by causing a screw or rod-shaped object to penetrate ring frame 30, glass body 10 and side frame 20.

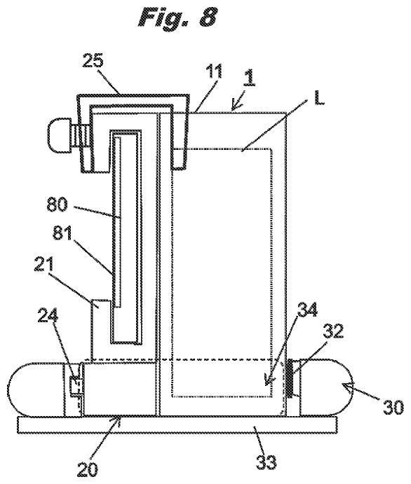

As shown in FIG. 8, an embodiment of the present invention may be provided with U-shaped clamping mechanism 25 that clamps the end of the upper portion of upper opening 11 of glass body 10 and the upper portion of side frame 20. By using clamping mechanism 25, it is possible to reinforce the fixation of the lower part of the glass body by screwing ring frame 30. As a result, the fixing strength between glass body 10 and side frame 20 further increases.

As a specific example of a realizing method of clamping mechanism 25, there are practically several choices:
method of applying tension using screws as shown in FIG. 8 (in a direction to sandwich the end of upper opening 11 and side frame 20);
method of applying tension using a spring mechanism; and
method of applying tension using elasticity or stress of an object, and the like.

The shape of clamping mechanism 25 is not particularly limited as long as it can fix upper opening 11 and the side frame 20 in a state where the end of the upper opening 11 and the upper portion of the side frame 20 are sandwiched (in this point, the U-shape is practical). As the material of clamping mechanism 25, resin, acrylic, glass, silicon rubber, stainless and steel etc., which are hard to get wet with water, are available.

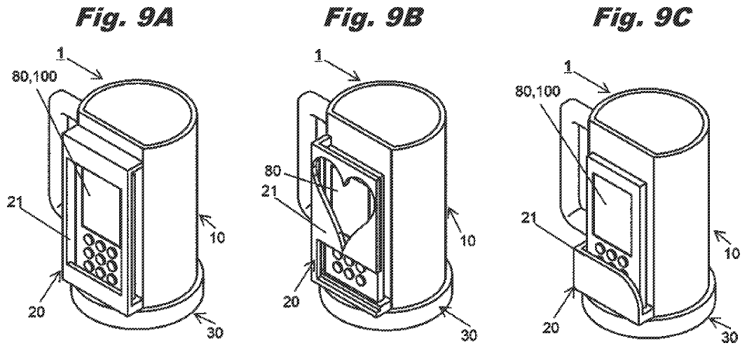

With the beverage entertainment glass 1 of the present invention, the user can unite or detach glass body 10 and side frame 20 only by screwing glass body 10 and side frame 20 into or out of ring frame 30 together. With this structure, the user can quickly exchange (or replace) side frames 20 that have various shapes in correspondence with the surrounding conditions and/or user's preferences. For example, when lovers or couples make a toast, a heart-shaped side frame 20 is screwed into ring frame 30 as shown in FIG. 9B to make the situation romantic. Also, when image display device 80 is portable communication device 100 such as a mobile phone or a smartphone, and the user wants to enjoy an application game installed into portable communication device 100, the user can replace the side frame with one having a wide open window as shown in FIG. 9A. Also, the size of side frame 20 (that is, fixing mechanism 21) may be replaced with one having a larger size in correspondence with the size of image display device 80 or portable communication device 100.

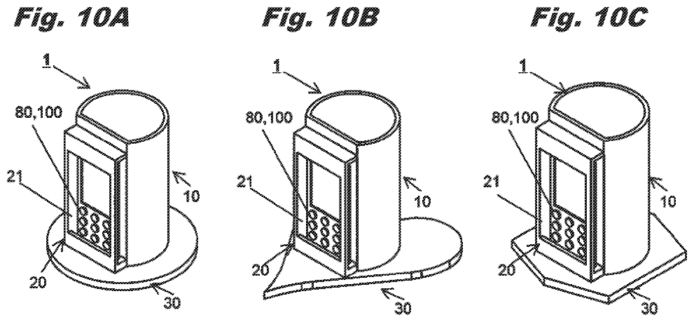

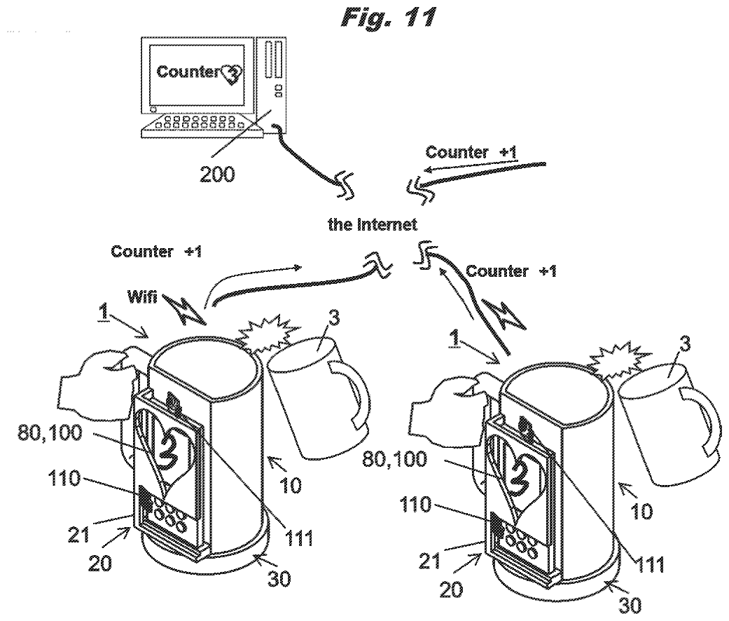

In beverage entertainment glass 1 of the present invention, ring frame 30 is placed at or near the bottom of glass body 10. As a result, the present invention can be used hygienically by allowing a spoon, sugar cube, etc. to be placed on the ring frame instead of a coaster. In situations where sugar cubes and spoons are needed, such as when drinking coffee, ring frame 30 can be exchanged with a large-sized ring frame 30 having a space for allowing a spoon and a sugar cube to be placed as shown in FIG. 10A. As described above, the beverage entertainment glass of the present invention has ring frame 30 at the bottom so that it functions as a glass coaster. Coasters having various designs are added to beverage entertainment glass 1 simply by exchanging ring frame 30.

Ring frame 30 is placed at or near the bottom of glass body 10. Therefore, even in the case where the height of glass body 10 is high or tall (that is, the center of gravity is high and it is easy to fall over), the glass body is prevented from falling over large ring frame 30 simply by the ring frame being exchanged with a large one (more specifically, another ring frame in FIG. 10A that has a large distance between the inner peripheral surface and the outer peripheral surface of ring frame 30). Accordingly, beverage entertainment glass 1 of the present invention can be applied to any type or size of glass body 10 having various heights. Exchanging/replacing of ring frame 30 can be executed only by turning or twisting ring frame 30 with user's hand UH as shown in FIG. 1 and FIG. 2.

### Embodiment(s) of Remote Toast Counter System

An embodiment of a remote toast counter system of the present invention is described below. The same reference numerals are given to the portions and parts having the same configuration in each of the above-described embodiments (or examples) of the beverage entertainment glass, and the description thereof are omitted.

Most models of portable communication devices such as mobile phones and smartphones incorporate acceleration sensors and camera sensors. Based on the acceleration of an object in which the acceleration sensor is equipped, the acceleration sensor acquires the amount of movement, the amount of tilt, and whether or not it has collided with another object. The camera sensor also uses image analysis to obtain the amount of movement, the amount of tilt, and whether or not it has collided with another object. Therefore, the remote toast counter system of the embodiment(s), as shown in FIG. 11, comprises beverage entertainment glass 1 of the present invention, portable communication device 100, external server computer 200, and user operation detection part 110.

Based on the signal from sensor 111 of portable communication device 100, user operation detection unit 110 detects user operation with respect to glass body 10 (collision with another drinking glass 3, or tilting operation, etc.), a signal related to the user operation is transmitted by user operation detection unit 110 to server computer 200 or the like in the distance. As shown in FIG. 11, remote server computer 200 in the distance counts the number of receptions of the signals from user operation detection unit 110 and the count is recorded as the total number of toasting operations. By making the total number of toasting operations available for viewing or available to public, the remote toast counter system is realized.

It is noted that user operation detection unit 110 may be mounted inside a dedicated IC chip attached to beverage entertainment glass 1, or may be mounted in an external server computer.

When participating in a toast network from a remote location to celebrate a wedding or the like, side frame 20 may be exchanged/replaced with a heart-shaped one as shown in FIG. 9B or FIG. 11. When sensor 111 of portable communication device 100 is a camera sensor, it is possible to photograph the shape of side frame 20 and transmit it to server computer 200 in the distance. As a result, only those who use heart-shaped side frames 20 may be extracted and counted as those who are celebrating their marriage.

According to the present invention, side frames that are in various designs can be exchanged according to the user's preference. As a result, a beverage entertainment glass and a remote toast counter system that make toasting situations more enjoyable are provided. For these reasons, the present invention has industrial applicability.

### LEGEND

L: Beverage (liquid)
UH: User's hand
R1: Curvature radius (glass body)
R2: Curvature radius (side frame)
1: Beverage entertainment glass
2: Beverage entertainment glass
3: Other drinking glass(es)
4: Other drinking glass(es)
10: Glass Body
11: Top opening
12: First curved surface
13: First connection surface
14: Elastic sheet
15: Lid
16: Protrusion part
20: Side frame
21: Fixing mechanism
22: Second curved surface
23: Second connection surface
24: 1st protrusion part
25: Clamping mechanism
26: Connection adhering surface (substitute for first protrusion part)
30: Ring frame
31: Second protrusion part
32: Contact surface
33: Bottom plate
35: Third protrusion part
36: Rotation stopper mechanism
37: Rubber sheet (rotation stopper mechanism)
40: connection part
80: Image display device
81: Image display part
100: Portable communication device
110: User operation detector
111: Sensor
200: External server computer(s)

What is claimed is:

1. A beverage entertainment glass comprising:
a glass body that is a tubular body with a bottom having an upper opening;
a side frame that has a fixing mechanism configured to fix an image display device to the glass body; and
a ring frame that is in a ring shape and into which the glass body and the side frame are inserted together, wherein
the glass body has a first curved surface that is curved on a side surface near a bottom thereof,
the glass body has a first connection surface at a position facing the first curved surface,
the side frame has a second curved surface that is curved on a side surface near a bottom thereof,
the side frame has a second connection surface at a position facing the second curved surface,
a first protrusion part is provided on the second curved surface,
a curvature radius of the first curved surface and a curvature radius of the second curved surface are equal,
a second protrusion part that is connected to the first protrusion part is provided on an inner peripheral surface of the ring frame,
a third protrusion part is provided on an inner peripheral surface of the ring frame,
the third protrusion part includes at least one contact surface that contacts any portion of the first curved surface,
by inserting the glass body and the side frame into the ring frame in a state where the first connection surface and the second connection surface are connected, the one contact surface of the third protrusion part contacts the first curved surface, and
by rotating the ring frame in a state where the one contact surface of the third protrusion part is in contact with the first curved surface, the second protrusion part connects to the first protrusion part such that the glass body is fixed to the side frame.

2. The beverage entertainment glass according to claim 1, further comprising:
a rotation stopper mechanism that holds or fixes the glass body and the side frame in a state where the glass body and the side frame are screwed into the ring frame.

3. The beverage entertainment glass according to claim 1, further comprising:
a clamping mechanism that is in a U-shape and clamps an end of the upper opening and an upper part of the side frame.

4. The beverage entertainment glass according to claim 1, wherein
the ring frame is provided with a bottom plate that protects a bottom surface of the glass body.

5. The beverage entertainment glass according to claim 1, wherein
the beverage entertainment glass includes a plurality of the first protrusion parts and/or a plurality of the second protrusion parts.

6. The beverage entertainment glass according to claim 1, wherein
the any portion of the first curved surface, which contacts the one contact surface of the third protrusion, is raised in a protrusion shape.

7. The beverage entertainment glass according to claim 1, further comprising
a lid that closes the upper opening.

8. The beverage entertainment glass according to claim 1, wherein
the image display device is a part of a portable communication device.

9. The beverage entertainment glass according to claim 1, wherein
instead of the first protrusion part, a connection adhering surface is provided on the second curved surface, the connection adhering surface connecting to or adhering to the second protrusion part.

10. A remote toast counter system, comprising:
the beverage entertainment glass according to claim 8;
the portable communication device that has an acceleration sensor or camera sensor;
an external server computer that communicates with the portable communication device via a network; and
a user operation detection part that receives output data of the acceleration sensor or camera sensor from the portable communication device, wherein
the user operation detection unit,
detects that the user moved, tilted, or collided the beverage entertainment glass with another object based on the output data of the acceleration sensor or camera sensor of the portable communication device, and
transmits an output signal related to the output date to the external server computer, and the external server computer
receives the output signal, and
calculates a toast operation cumulative number by counting the number of receptions of the output signals from the user operation detection part such that the user can view the toast operation cumulative number.

11. A beverage entertainment glass, comprising:
a glass body that is a tubular body with a bottom having an upper opening;
a side frame that has a fixing mechanism configured to fix an image display device to the glass body; and
a ring frame that is in a ring shape and into which the glass body and the side frame are inserted together, wherein
the glass body has a first curved surface that is curved on a side surface near a bottom thereof,
the glass body has a first connection surface at a position facing the first curved surface,
the side frame has a second curved surface that is curved on a side surface near a bottom thereof,
the side frame has a second connection surface at a position facing the second curved surface,
a connection adhering surface is provided on the second curved surface, the connection adhering surface connecting to or adhering to the second protrusion part,
a curvature radius of the first curved surface and a curvature radius of the second curved surface are equal,
a second protrusion part that is connected to the connection adhering surface is provided on an inner peripheral surface of the ring frame,
a third protrusion part is provided on an inner peripheral surface of the ring frame,
the third protrusion part includes at least one contact surface that contacts any portion of the first curved surface,
by inserting the glass body and the side frame into the ring frame in a state where the first connection surface and the second connection surface are connected, the one contact surface of the third protrusion part contacts the first curved surface,
by rotating the ring frame in a state where the one contact surface of the third protrusion part is in contact with the first curved surface, the second protrusion part connects to the connection adhering surface such that the glass body is fixed to the side frame, and
the any portion of the first curved surface, which contacts the one contact surface of the third protrusion, is raised in a protrusion shape.
